(19) United States
(12) Patent Application Publication
(10) Pub. No.: US 2026/0015446 A1
(43) Pub. Date: Jan. 15, 2026

(54) NOVEL HIGHLY DURABLE CROSS-LINKED POLY(ARYL PIPERIDINIUM) COPOLYMER IONOMER, ANION-EXCHANGE MEMBRANE, AND METHOD FOR MANUFACTURING SAME

(71) Applicant: IUCF-HYU (INDUSTRY-UNIVERSITY COOPERATION FOUNDATION HANYANG UNIVERSITY, Seoul (KR)

(72) Inventors: Young Moo LEE, Seoul (KR); Nayoon KANG, Seoul (KR); Chuan HU, Seoul (KR); Nanjun CHEN, Seoul (KR)

(73) Assignee: IUCF-HYU (INDUSTRY-UNIVERSITY COOPERATION FOUNDATION HANYANG UNIVERSITY, Seoul (KR)

(21) Appl. No.: 18/993,687

(22) PCT Filed: Jul. 11, 2023
(86) PCT No.: PCT/KR2023/009890

§ 371 Date: Jan. 13, 2025

(30) Foreign Application Priority Data
Jul. 14, 2022 (KR) 10-2022-0087185
Oct. 4, 2022 (KR) 10-2022-0126050

(51) Int. Cl. C08F 226/06; B01D 67/00; B01D 69/12; B01D 71/44

(52) U.S. Cl. CPC C08F 226/06; B01D 67/0093; B01D 69/125; B01D 71/44

(57) ABSTRACT

The present disclosure relates to a cross-linked poly(aryl piperidinium) copolymer ionomer, with no aryl ether bond in the polymer backbone, in which a piperidinium group cross-linked by a polystyrene linker is introduced in a repeating unit, wherein the ionomer exhibits remarkably excellent chemical stability, ion conductivity, mechanical properties, dimensional stability, and durability. In addition, an anion-exchange membrane manufactured from the cross-linked poly(aryl piperidinium) copolymer ionomer has suppressed excessive swelling and greatly improved mechanical properties, alkaline stability and durability, and allow operation even under low-humidity conditions. Thus, it can be applied to membranes and binders for alkaline fuel cells, water electrolysis devices, carbon dioxide reduction, or oxidation-reduction flow batteries.

### TECHNICAL FIELD

The present disclosure relates to a novel highly durable cross-linked poly(aryl piperidinium) copolymer ionomer, an anion-exchange membrane, and a method for preparing the same, more specifically to the synthesis of a cross-linked poly(aryl piperidinium) copolymer ionomer, with no aryl ether bond in the polymer backbone, in which a piperidinium group cross-linked by a polystyrene linker is introduced in a repeating unit, and preparation of an anion-exchange membrane therefrom for application to alkaline fuel cells, water electrolysis devices, etc.

### BACKGROUND ART

Since alkaline membrane fuel cells (AMFCs) and water electrolysis devices using anion-exchange membranes can utilize inexpensive non-precious metals such as nickel, manganese etc. as electrocatalysts instead of platinum, and are known to have excellent performance and extremely high price competitiveness, continuous researches are being carried out thereon. However, because of poor long-term stability problems caused by the decomposition of hydroxyl radicals and ions during operation, researches are needed to improve the durability of the alkaline membrane fuel cells.

Ordinary alkaline polymer electrolytes (APEs) are composed of a polymer backbone and cationic groups, which maintain mechanical strength and move OH⁻ and water molecules, respectively. However, since many APEs have limited alkaline stability (500 h or shorter at 80° C. in 1 M NaOH), insufficient ion conductivity, and poor mechanical properties (tensile strength <30 MPa) due to weak polymer backbones (ether-containing structures) and cationic groups (e.g. benzyltrimethylammonium), the existing anion-exchange membrane fuel cells (AEMFCs) have the problems of low output density (<1 Wcm⁻²) and cell durability.

In addition, the conventional APEs have a trade-off relationship between ion conductivity and dimensional stability. APEs require sufficient conductivity to facilitate ion transport. Although high ion exchange capacity (IEC) is the most direct method for improving conductivity, high IEC has the disadvantage of damaging the dimensional stability and mechanical properties of the APE by inducing high water uptake (WU) and swelling ratio (SW). In particular, a mechanically tough membrane is very important for long-term operation of an alkaline energy device. Since the existing APE has stability problem due to mechanical defects such as cracks and holes after an alkaline stability test, the lifespan of the alkaline energy device is shortened.

Until now, a poly(aryl piperidinium) ionomer, with no aryl ether bond in the polymer backbone, in which a piperidinium group cross-linked by a polystyrene linker is introduced in a repeating unit, has not been synthesized yet, and there is no specific knowledge about the technology of applying it to membranes or binders for alkaline fuel cells, or water electrolysis.

Therefore, the inventors of the present disclosure have researched to expand the application of aromatic polymer ion-exchange membranes with excellent thermal and chemical stability and mechanical properties. They have sought to solve the problems of conventional APEs such as low chemical stability, ion conductivity, mechanical properties, dimensional stability, and durability by introducing a poly(aryl piperidinium) ionomer, with no aryl ether bond in the polymer backbone, in which a piperidinium group cross-linked by a polystyrene linker is introduced in a repeating unit.

In other words, the present disclosure was completed by discovering that a poly(aryl piperidinium) copolymer ionomer, with no aryl ether bond in the polymer backbone, in which a piperidinium group cross-linked by a polystyrene linker is introduced in a repeating unit, and an anion-exchange membrane prepared therefrom can be applied to membranes and binders for alkaline fuel cells, water electrolysis devices, carbon dioxide reduction, oxidation-reduction flow batteries, etc.

### REFERENCES OF RELATED ART

### Patent Documents

Patent document 1: Korean Patent Publication No. 10-2018-0121961.
Patent document 2: International Patent Publication No. WO 2019/068051.
Patent document 3: Japanese Patent Publication No. JP 2020-536165.
Patent document 4: US Patent Publication No. US 2019/0036143.

### DISCLOSURE

### Technical Problem

The present disclosure was designed in consideration of the problems described above, and is directed to providing a novel cross-linked poly(aryl piperidinium) copolymer ionomer having high chemical stability, ion conductivity, mechanical properties, dimensional stability and durability, and a method for preparing the same.

The present disclosure is also directed to preparing an anion-exchange membrane from the novel cross-linked poly(aryl piperidinium) copolymer ionomer, thereby suppressing excessive swelling of the membrane and greatly improving mechanical properties, alkaline stability and durability, thus allowing application to membranes and binders for alkaline fuel cells, water electrolysis devices, carbon dioxide reduction, or oxidation-reduction flow batteries.

### Technical Solution

The present disclosure provides a cross-linked poly(aryl piperidinium) copolymer ionomer having a repeating unit represented by <Chemical Formula 1>:

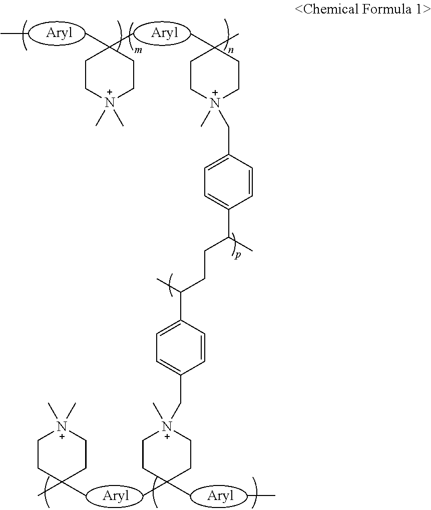

wherein Aryl represents two different types of compounds selected from the compounds represented by the following structural formulas:

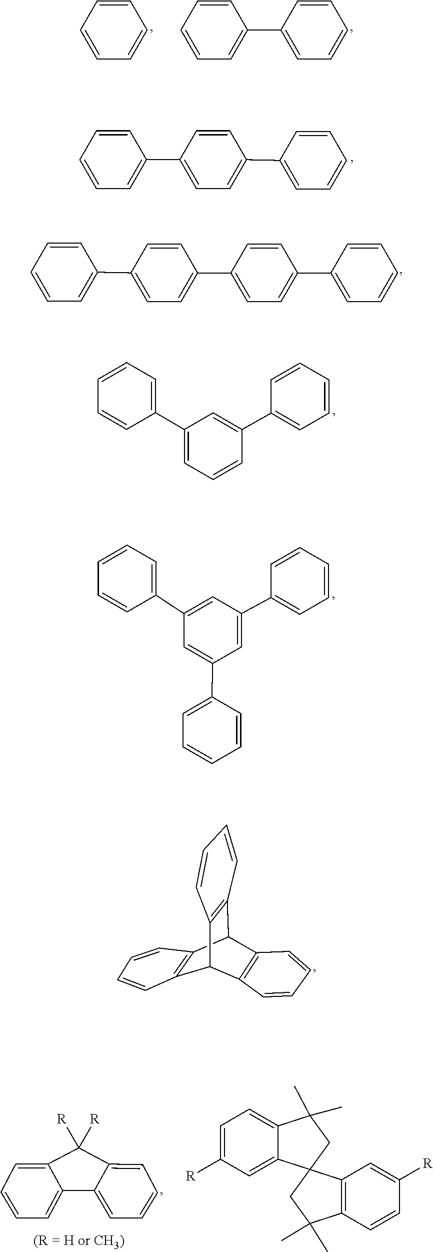

or C₁₋₅ alkoxy),

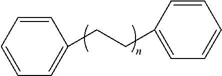

(n is an integer from 1 to 10); and
m and n are mole fractions (%) of in the repeating unit of the copolymer ionomer, wherein m>0, n>0, m+n=100, and p indicates degree of crosslinking adjusted to 20% or lower.

Also, the present disclosure provides a method for preparing a cross-linked poly(aryl piperidinium) copolymer ionomer, which includes:
(I) a step of forming a solution by dissolving (a) two different types of compounds selected from compounds represented by the following structural formulas as monomers, and (b) 1-methyl-4-piperidone in an organic solvent;

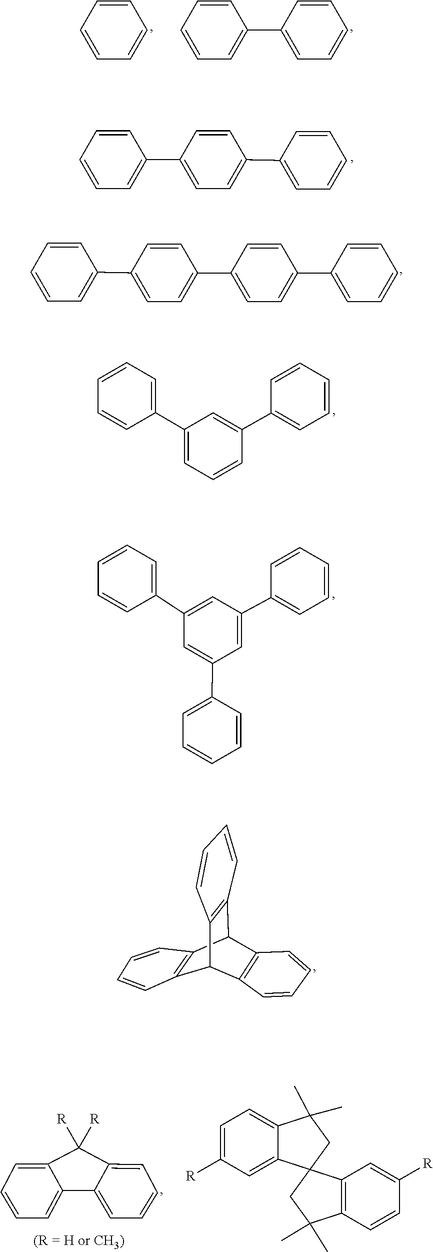

or C₁₋₅ alkoxy),

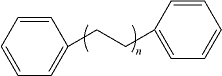

(n is an integer from 1 to 10);
(II) a step of obtaining a viscous solution by gradually adding a strong acid catalyst to the solution and stirring and reacting the same; (III) a step of obtaining a solid polymer by precipitating, washing and drying the viscous solution; (IV) a step of forming a quaternary piperidinium salt containing a styrene group by adding K₂CO₃, 4-vinylbenzyl chloride and an excessive amount of halomethane to a polymer solution in which the solid polymer and the strong acid catalyst are dissolved in an organic solvent and reacting the same; and (V) a step of precipitating, washing, drying and then heat-treating the polymer solution.

The present disclosure also provides an anion-exchange membrane containing the cross-linked poly(aryl piperidinium) copolymer ionomer.

The present disclosure also provides a method for preparing an anion-exchange membrane, which includes: (i) a step of forming a polymer solution by dissolving the cross-linked poly(aryl piperidinium) copolymer ionomer in an organic solvent; (ii) a step of removing the organic solvent and obtaining a membrane in which crosslinking between styrene groups has been induced simultaneously by casting the polymer solution onto a glass plate and heating the same; and (iii) a step of treating the obtained membrane with 1 M NaHCO₃ or 1 M NaOH and then washing several times with ultrapure water and drying the same.

The present disclosure also provides a binder for an alkaline fuel cell, which contains the cross-linked poly(aryl piperidinium) copolymer ionomer.

In addition, the present disclosure provides an alkaline fuel cell including the anion-exchange membrane.

In addition, the present disclosure provides a water electrolysis device including the anion-exchange membrane.

In addition, the present disclosure provides a carbon dioxide reduction device including the anion-exchange membrane.

The present disclosure also provides an oxidation-reduction flow battery including the anion-exchange membrane.

### Advantageous Effects

A novel cross-linked poly(aryl piperidinium) copolymer ionomer according to the present disclosure has excellent chemical stability, ion conductivity, mechanical properties, dimensional stability, and durability.

Furthermore, an anion-exchange membrane prepared from the cross-linked poly(aryl piperidinium) copolymer ionomer not only has greatly improved mechanical durability, but also improved capacity of holding moisture in the membrane, allowing the operation of a fuel cell even under low-humidity conditions.

In addition, by using a hydrophobic crosslinking agent, the gas permeability of the catalyst layer is improved, the problem of cathode flooding is mitigated and, in particular, the adhesion of the ionomer within the catalyst layer is improved due to in-situ crosslinking, and the in-situ durability of a fuel cell and a water electrolysis device is also improved significantly.

### BRIEF DESCRIPTION OF DRAWINGS

FIG. 1A shows the swelling ratio depending on temperature and FIG. 1B shows ion conductivity (OH⁻) over time of some of anion-exchange membranes (OH-form) prepared in Example 7 of the present disclosure (prepared from copolymer ionomers obtained in Examples 1 to 6) and anion-exchange membranes prepared in Comparative Examples 1 and 2.

FIGS. 2A to 2F show atomic force microscope (AFM) images showing the ion channel size and phase separation of some of anion-exchange membranes (I-form) prepared in Example 7 of the present disclosure (prepared from copolymer ionomers obtained in Examples 1 to 6) and anion-exchange membranes prepared in Comparative Examples 1 and 2.

FIG. 3A shows the mechanical properties at room temperature and FIG. 3B shows dynamic mechanical properties of some of anion-exchange membranes (I-form) prepared in Example 7 of the present disclosure (prepared from copolymer ionomers obtained in Examples 1 to 6) and anion-exchange membranes prepared in Comparative Examples 1 and 2.

FIGS. 4A to 4D show a result of ex-situ durability tests of some of anion-exchange membranes (OH-form) prepared in Example 7 of the present disclosure (prepared from copolymer ionomers obtained in Examples 1 to 6) and anion-exchange membranes prepared in Comparative Examples 1 and 2 before and after immersion in 1 M NaOH at 80° C. for 2, 160 hours [(A) change in OH-conductivity at 30° C., (B) ¹H NMR spectra of x-PFTP-PS-10, (C) mechanical properties of anion-exchange membranes in OH-form after durability test, (D) thermogravimetric analysis (TGA) characteristics of x-PFTP-PS-10].

FIGS. 5A to 5D show a result of testing the fuel cell performance of some of anion-exchange membranes (OH-form) prepared in Example 7 of the present disclosure (prepared from copolymer ionomers obtained in Examples 1 to 6) and anion-exchange membranes prepared in Comparative Examples 1 and 2 at low relative humidity and high temperature [test condition: A/C PFTP ionomer, 1,000/1,000 mL min⁻¹ H₂—O₂ flow rate, 0.33 mg cm⁻² A/C Pt/C, 90° C., 1.3/1.3 bar A/C pressure, (A) PFTP, (B) x-PFTP-PS-10, (C) x-PDTP-PS-20, (D) peak power density (PPD) of fuel cells at different relative humidity].

FIGS. 6A to 6D show the water electrolysis performance of different anion-exchange membranes at 2.0 V [test condition: A/C PFBP-14 ionomer, 1 M KOH feed, A/C IrO₂/Pt/C, (A) I-V curve measured at 60° C., (B) electrochemical impedance spectroscopy (EIS) spectrum, (C) I-V curve measured at 80° C., (D) electrochemical impedance spectroscopy (EIS) spectrum].

### BEST MODE

Hereinafter, a novel highly durable cross-linked poly(aryl piperidinium) copolymer ionomer, an anion-exchange membrane, and a method for preparing the same according to the present disclosure will be described in detail.

The present disclosure provides a cross-linked poly(aryl piperidinium) copolymer ionomer having a repeating unit represented by <Chemical Formula 1>:

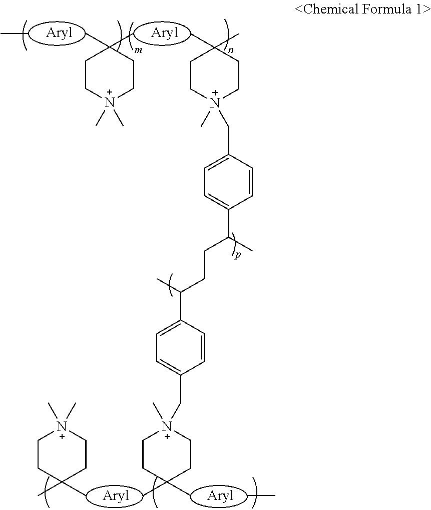

wherein Aryl represents two different types of compounds selected from the compounds represented by the following structural formulas:

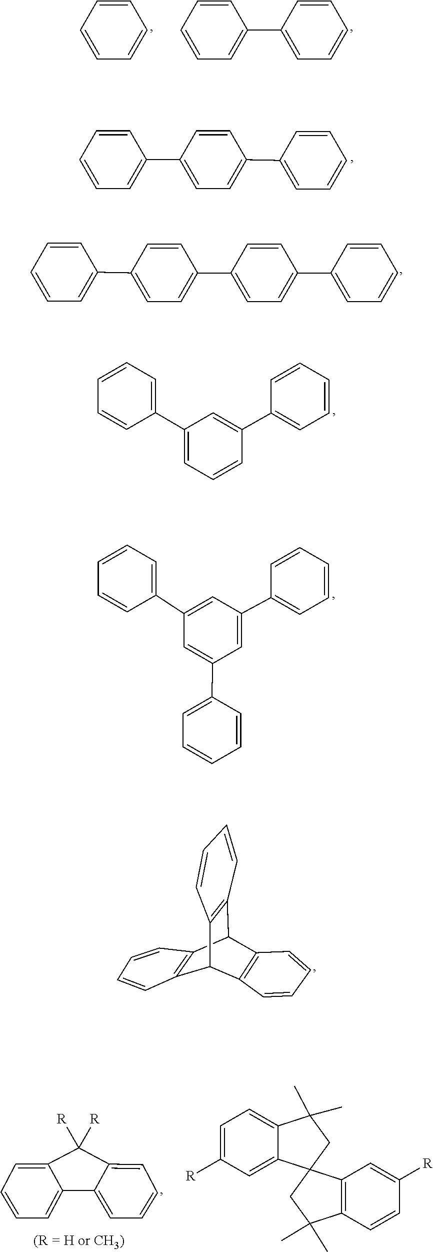

or C₁₋₅ alkoxy),

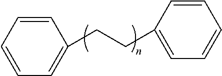

(n is an integer from 1 to 10); and
m and n are mole fractions (%) of in the repeating unit of the copolymer ionomer, wherein m>0, n>0, m+n=100, and p indicates degree of crosslinking adjusted to 20% or lower.

As shown in Chemical Formula 1, since the cross-linked poly(aryl piperidinium) copolymer ionomer according to the present disclosure has no aryl ether group in the polymer backbone and contains a piperidinium group cross-linked by a polystyrene linker, it has excellent membrane-forming ability and chemical stability.

Furthermore, ion conductivity, mechanical properties, dimensional stability, and durability are improved greatly. In particular, since vinylbenzyl chloride, which is a hydrophobic crosslinking agent, is used to form the crosslinked structure, the alkaline stability of APE is improved, and swelling and ion conductivity are balanced.

Furthermore, the gas permeability of a catalyst layer of an alkaline fuel cells is improved, the problem of cathode flooding is mitigated, and, in particular, the adhesion of the ionomer within the catalyst layer is improved due to in-situ crosslinking, and the in-situ durability of a fuel cell and a water electrolysis device is also improved significantly.

The present also disclosure provides a method for preparing a cross-linked poly(aryl piperidinium) copolymer ionomer, which includes:
(I) a step of forming a solution by dissolving (a) two different types of compounds selected from compounds represented by the following structural formulas as monomers, and (b) 1-methyl-4-piperidone in an organic solvent;

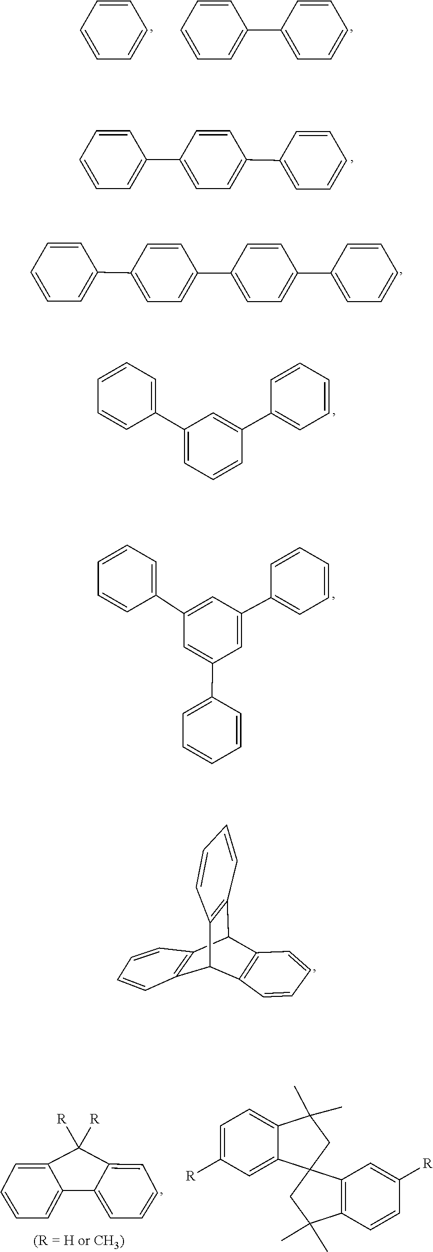

or C₁₋₂ alkoxy),

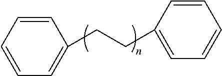

(n is an integer from 1 to 10)
(II) a step of obtaining a viscous solution by gradually adding a strong acid catalyst to the solution and stirring and reacting the same; (III) a step of obtaining a solid polymer by precipitating, washing and drying the viscous solution; (IV) a step of forming a quaternary piperidinium salt containing a styrene group by adding K₂CO₃, 4-vinylbenzyl chloride and an excessive amount of halomethane to a polymer solution in which the solid polymer and the strong acid catalyst are dissolved in an organic solvent and reacting the same; and (V) a step of precipitating, washing, drying and then heat-treating the polymer solution.

The organic solvent in the step (I) may be one or more halogen-based solvent selected from a group consisting of dichloromethane, chloroform, dichloroethane, dibromomethane and tetrachloroethane. Specifically, dichloromethane may be used.

And, the strong acid catalyst in step (II) or (IV) may be trifluoroacetic acid, trifluoromethanesulfonic acid, pentafluoroethanesulfonic acid, heptafluoro-1-propanesulfonic acid, perfluoropropionic acid, heptafluorobutyric acid, or a mixture thereof.

And, the organic solvent in the step (IV) may be N-methylpyrrolidone, dimethylacetamide, dimethyl sulfoxide or dimethylformamide.

In the step (IV), the polymer is reacted with a halomethane to form a quaternary piperidinium salt. The halomethane may be fluoromethane, chloromethane, bromomethane or iodometane. Specifically, iodometane may be used.

The present disclosure also provides an anion-exchange membrane containing the cross-linked poly(aryl piperidinium) copolymer ionomer.

The anion-exchange membrane according to the present disclosure not only has greatly improved mechanical durability, but also shows a limited swelling ratio, has well-controlled ion conductivity and dimensional stability, and also exhibits improved moisture holding capacity, thus allowing operation of a fuel cell even under low-humidity conditions.

The present disclosure also provides a method for preparing an anion-exchange membrane, which includes: (i) a step of forming a polymer solution by dissolving the cross-linked poly(aryl piperidinium) copolymer ionomer in an organic solvent; (ii) a step of removing the organic solvent and obtaining a membrane in which crosslinking between styrene groups has been induced simultaneously by casting the polymer solution onto a glass plate and heating the same; and (iii) a step of treating the obtained membrane with 1 M NaHCO₃ or 1 M NaOH and then washing several times with ultrapure water and drying the same.

The organic solvent in the step (i) may be N-methylpyrrolidone, dimethylacetamide, dimethyl sulfoxide or dimethylformamide.

And, the concentration of the polymer solution may be specifically 2 to 30 wt %, more specifically 3.0 to 5.0 wt %. If the concentration of the polymer solution is below 2 wt %, the ability of forming a membrane may decrease. And, if it exceeds 30 wt %, the physical properties of the membrane may deteriorate after formation because the viscosity is too high.

Also, in the step (ii), the organic solvent is slowly removed in an oven at 80 to 90° C. for 24 hours. Then, by heating in a vacuum oven at 120 to 150° C. for 12 hours, the organic solvent is removed completely and, at the same time, crosslinking between styrene groups is induced.

The synthesis of the cross-linked poly(aryl piperidinium) copolymer ionomer according to the present disclosure can be represented by Scheme 1.

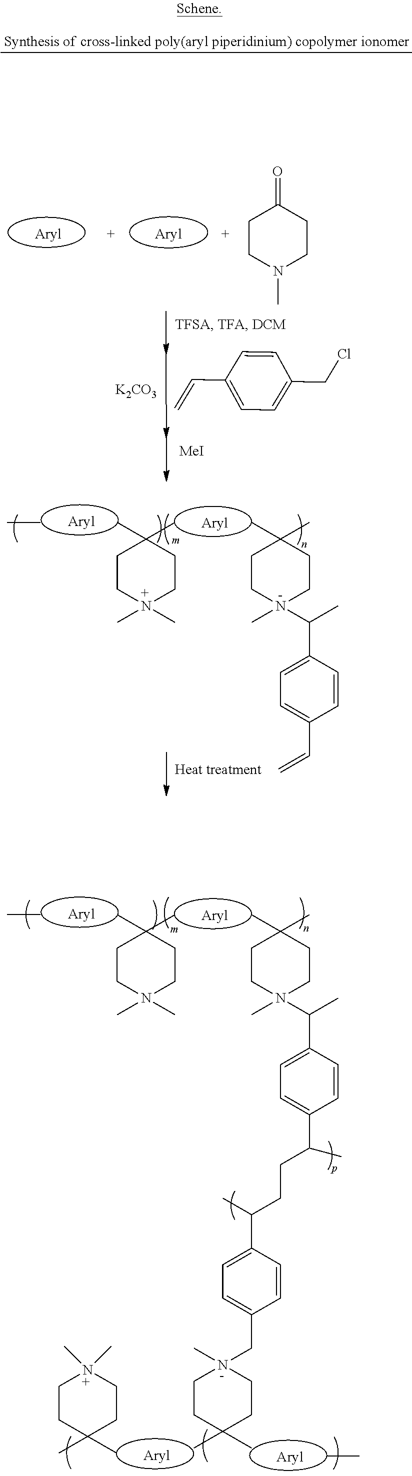

(Aryl, m, n, and p are the same as defined in Chemical Formula 1)

The present disclosure also provides a binder for an alkaline fuel cell, which contains the cross-linked poly(aryl piperidinium) copolymer ionomer.

In addition, the present disclosure provides an alkaline fuel cell including the anion-exchange membrane.

In addition, the present disclosure provides a water electrolysis device including the anion-exchange membrane.

In addition, the present disclosure provides a carbon dioxide reduction device including the anion-exchange membrane.

The present disclosure also provides an oxidation-reduction flow battery including the anion-exchange membrane.

Hereinafter, examples and comparative examples according to the present disclosure will be explained in detail referring to the attached drawings.

### [Examples 1 and 2] Preparation of Cross-Linked Poly(Aryl Piperidinium) Copolymer Ionomers

Diphenylethane (1.0252 g, 5.625 mmol), terphenyl (3.885 g, 16.857 mmol), and 1-methyl-4-piperidone (2.8005 g, 24.750 mmol) were put into a 100-mL reactor as monomers. Then, dichloromethane (DCM, 18 mL) was added and a solution was formed by dissolving the monomers through stirring. After cooling the solution to −1° C., a mixture of trifluoroacetic acid (TFA, 2.7 mL) and trifluoromethanesulfonic acid (TFSA, 18 mL) was slowly added to the solution. The mixture was stirred and reacted for 2 hours to obtain a viscous solution. A solid poly(diphenyl-co-terphenyl N-methylpiperidine) polymer was prepared by pouring the viscous solution to 500 ml of distilled water, precipitating, washing several times with deionized water, and drying the same in an oven at 70° C. for 24 hours.

Next, a polymer solution was obtained by dissolving the prepared polymer (4 g, 8.63 mmol) and trifluoroacetic acid (TFA, 0.64 mL) in dimethyl sulfoxide (80 mL). Then, the polymer solution was stirred continuously for 24 hours at room temperature after adding K₂CO₃ (2.98 g, 21.57 mmol) and 4-vinylbenzyl chloride (0.1317 g, 0.863 mmol). Thereafter, iodomethane (CH₃I, 4.4 g, 31 mmol) was added to the polymer solution and reaction was conducted at room temperature in a dark room for 24 hours to form a quaternary piperidinium salt. Next, a solid cross-linked poly(aryl piperidinium) copolymer ionomer (degree of crosslinking=10%) was prepared by precipitating the polymer solution in 800 mL of ethyl acetate, washing several times with deionized water, and drying the same in a vacuum oven at 50° C. for 24 hours, and it was named x-PDTP-PS-10 (Example 1).

Also, a cross-linked poly(aryl piperidinium) copolymer ionomer was prepared by the same method as in Example 1, except that the degree of crosslinking was adjusted to 20%, and it was named x-PDTP-PS-20 (Example 2).

### [Examples 3 and 4] Preparation of Cross-Linked Poly(Aryl Piperidinium) Copolymer Ionomers

Cross-linked poly(aryl piperidinium) copolymer ionomers were prepared by the same method as in Examples 1 and 2, except that 9,9′-dimethylfluorene was used instead of the diphenylethane in Examples 1 and 2, and they were named x-PFTP-PS-10 (degree of crosslinking=10%, Example 3) and x-PFTP-PS-20 (degree of crosslinking=20%, Example 4), respectively.

### [Examples 5 and 6] Preparation of Cross-Linked Poly(Aryl Piperidinium) Copolymer Ionomers

Cross-linked poly(aryl piperidinium) copolymer ionomers were prepared by the same methods as in Examples 3 and 4, except that biphenyl was used instead of the terphenyl in Examples 3 and 4, and they were named x-PFBP-PS-10 (degree of crosslinking=10%, Example 5) and x-PFBP-PS-20 (degree of crosslinking=20%, Example 6), respectively.

As a result of nuclear magnetic resonance (1H NMR) analysis of the cross-linked poly(aryl piperidinium) copolymer ionomers prepared in Examples 1 to 6, the formation of a cross-linked structure was confirmed from the chemical shift (5.3 ppm, 5.8 ppm, 6.75 ppm) of the vinyl group (—CH₂═CH—) in 4-vinylbenzyl chloride.

### [Example 7] Preparation of Anion-Exchange Membranes from Cross-Linked Poly(Aryl Piperidinium) Copolymer Ionomers

A polymer solution was formed by dissolving each of the cross-linked poly(aryl piperidinium) copolymer ionomers (1.0 g) prepared in Examples 1 to 6 in dimethyl sulfoxide (25 mL). The polymer solution was then filtered with a 0.45-μm PTFE filter, and the resulting transparent solution was cast on a 21×24 cm glass plate. The casting solution was heated in an oven at 90° C. for 24 hours, and heated further in a vacuum oven at 140° C. for 12 hours to completely remove the solvent and, simultaneously, a light yellow transparent membrane in which crosslinking between styrene groups was induced was obtained through the heating.

An anion-exchange membrane was prepared by immersing the obtained membrane in I⁻ form in a 1 M NaOH aqueous solution for 24 hours to convert the counter ion to OH⁻, washing several times with ultrapure water and drying the same (The obtained anion-exchange membrane samples were named in the same manner as the cross-linked poly(aryl piperidinium) copolymer ionomers prepared in Examples 1 to 6).

### [Comparative Example 1] Preparation of Anion-Exchange Membrane from Poly(Aryl Piperidinium) Copolymer Ionomer with No Cross-Linked Structure

An anion-exchange membrane with no cross-linked structure was prepared by the same method as in Example 7 using a poly(diphenyl-co-terphenyl-N, N-dimethylpiperidinium) copolymer ionomer obtained by the same method as in Example 1, except that 4-vinylbenzyl chloride was not added for crosslinking, and it was named PDTP (or PDTP-25: mole fraction of diphenyl block in the repeating unit=25%).

### [Comparative Example 2] Preparation of Anion-Exchange Membranes from Poly(Aryl Piperidinium) Copolymer Ionomer with No Cross-Linked Structure

An anion-exchange membrane with no cross-linked structure was prepared by the same method as in Example 7 using a poly(fluorene-co-terphenyl-N,N-dimethylpiperidinium) copolymer ionomer obtained by the same method as in Example 3, except that 4-vinylbenzyl chloride was not added for crosslinking, and it was named PFTP (or PFTP-8: mole fraction of fluorenyl block in the repeating unit=8%).

### Test Example

Test data such as the mechanical properties, ion exchange capacity (IEC), water uptake (WU), swelling ratio (SR), water retention capacity (A), ion conductivity, fuel cell performance, etc. of the anion-exchange membranes prepared from the examples and comparative examples of the present disclosure were measured and evaluated according to the methods described in Korean Patent Publication No. 10-2021-0071810 filed by the inventors of the present disclosure.

First, the ion exchange capacity (IEC), water uptake (WU), swelling ratio (SR), water retention rate (lambda), and ion conductivity (o) of the anion-exchange membranes prepared in Example 7 (prepared from the copolymer ionomers obtained in Examples 1 to 4) and the anion-exchange membranes prepared in Comparative Examples 1 and 2 are shown in Table 1.

TABLE 1

| | IEC^{a} | | | | | | |
|---|---|---|---|---|---|---|---|
| Anion-exchange | (mmolg⁻¹) | WU (%) | | SR (%) | | | σ(OH⁻)^{b} |
| membrane | Titra | 30° C. | 80° C. | 30° C. | 80° C. | λ^{b} | (mS cm⁻¹) |
| x-PDTP-PS-10 | 2.69 | 50 ± 5 | 75 ± 5 | 12 ± 3 | 21 ± 3 | 10.3 | 53 |
| x-PDTP-PS-20 | 2.72 | 32 ± 5 | 63 ± 5 | 7 ± 3 | 16 ± 3 | 6.5 | 49 |
| x-PFTP-PS-10 | 2.63 | 70 ± 6 | 90 ± 5 | 16 ± 3 | 21 ± 3 | 14.7 | 65 |
| x-PFTP-PS-20 | 2.34 | 32 ± 5 | 51 ± 5 | 10 ± 2 | 12 ± 3 | 7.6 | 43 |
| PDTP | 2.80 | 110 ± 5 | 175 ± 5 | 31 ± 4 | 45 ± 5 | 21.8 | 75 |
| PFTP | 2.78 | 92 ± 10 | 110 ± 8 | 23 ± 3 | 31 ± 3 | 18.4 | 67 |

^{a}OH⁻ form;
^{b}at 30° C.

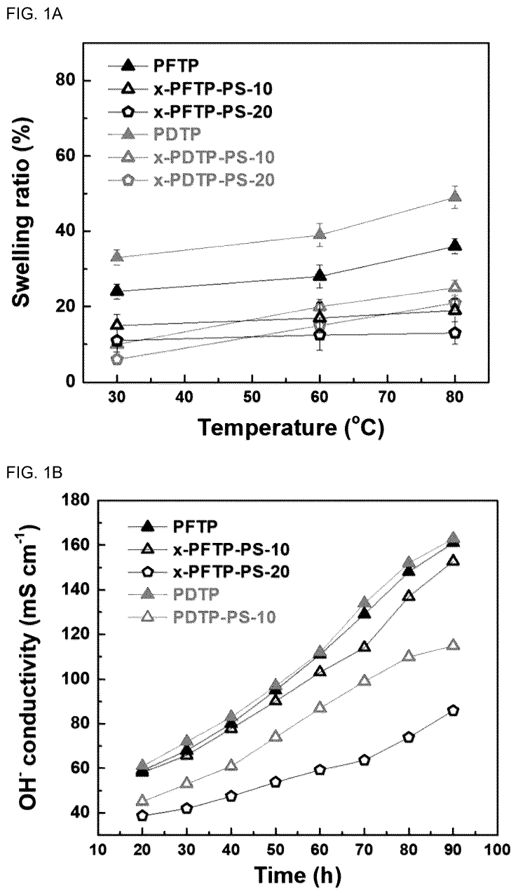

Also, the swelling ratio depending on temperature (a), and the ion conductivity (OH⁻ conductivity) over time (b) of some of the anion-exchange membranes (OH-form) prepared in Example 7 of the present disclosure (prepared from the copolymer ionomers obtained in Examples 1 to 6) and the anion-exchange membranes prepared in Comparative Examples 1 and 2 are shown in FIG. 1.

As shown in Table 1 and FIG. 1, it can be seen that the anion-exchange membrane having a cross-linked structure exhibits better dimensional stability. An anion-exchange membrane with a low swelling ratio (50%) is a very important element for a high-performance fuel cell.

Furthermore, the anion-exchange membrane with a cross-linked structure showed slightly lower ion conductivity than the anion-exchange membrane with no cross-linked structure due to its low ion exchange capacity and the hydrophobic crosslinking agent. In particular, the x-PFTP-PS-10 anion-exchange membrane exhibited a high OH-conductivity of 150 mS cm-1 or higher at 90° C., which has been evaluated as superior to most anion-exchange membranes.

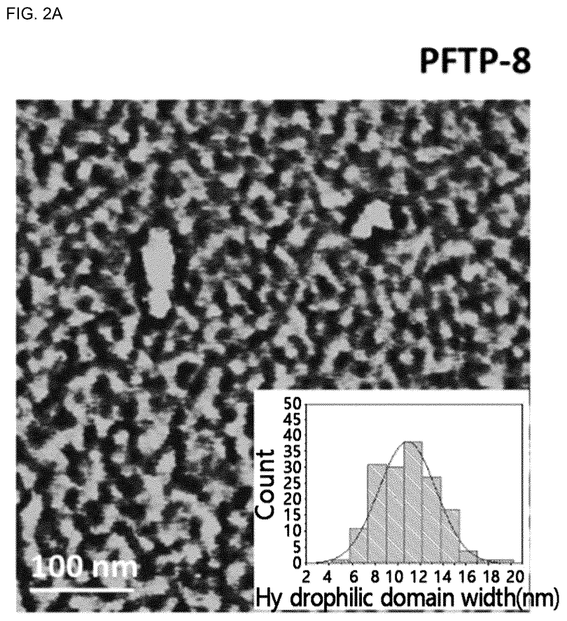

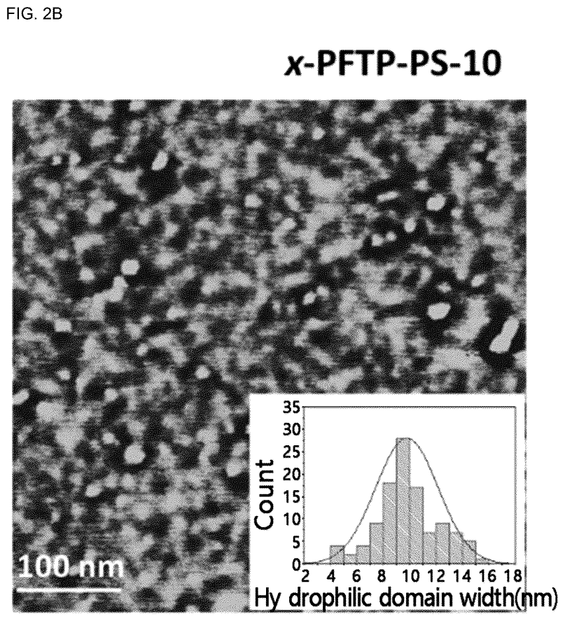

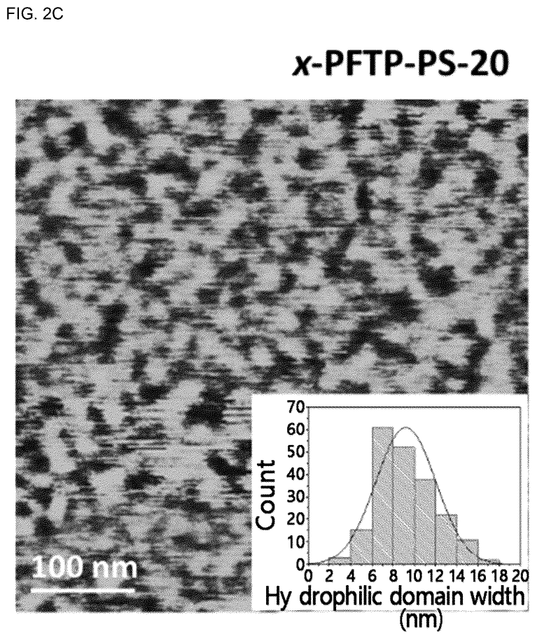

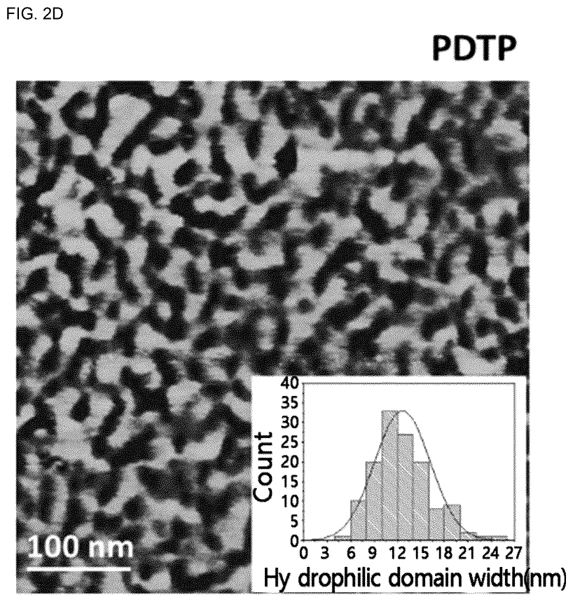

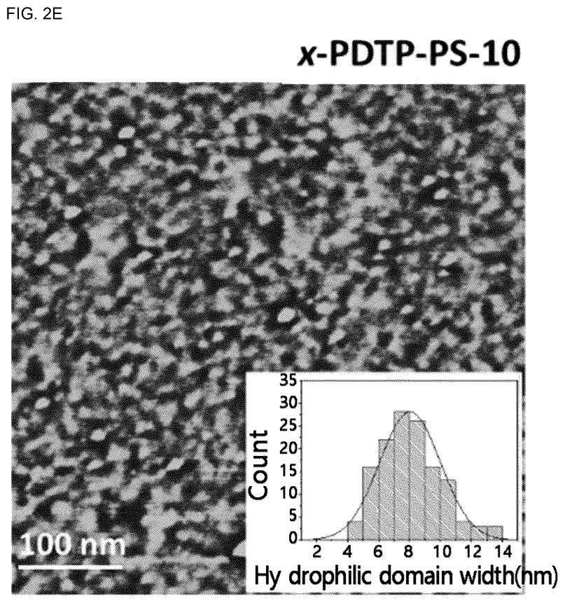

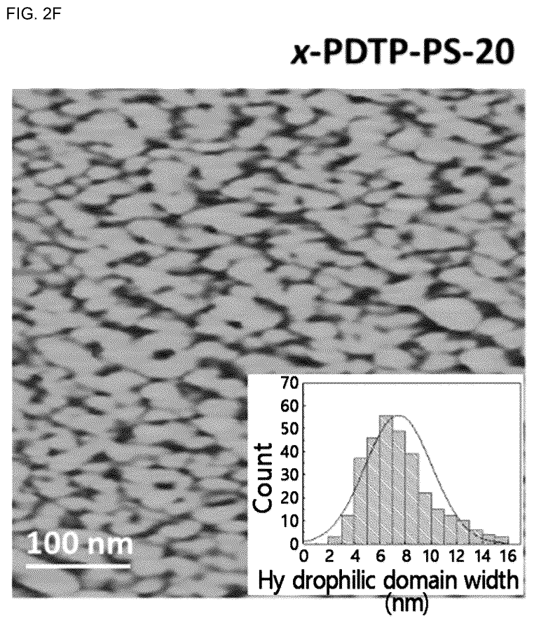

FIG. 2 shows the atomic force microscope (AFM) images showing the ion channel size and phase separation of some of the anion-exchange membranes (I-form) prepared in Example 7 of the present disclosure (prepared from copolymer ionomers obtained in Examples 1 to 6) and the anion-exchange membranes prepared in Comparative Examples 1 and 2.

In FIG. 2, the dark regions denote the hydrophilic phase aggregated by ammonium groups and bound water, while the yellow regions represent the hydrophobic phase formed by the rigid polymer. All the anion-exchange membranes display a clear hydrophilic/hydrophobic phase-separated morphology with similar features, while the width and area ratios of the hydrophilic phase regions (ion channels) are different. Compared to the anion-exchange membranes with no cross-linked structure, the anion-exchange membranes with a cross-linked structure exhibited narrower but continuous ion channels due to the hydrophobic crosslinking agent.

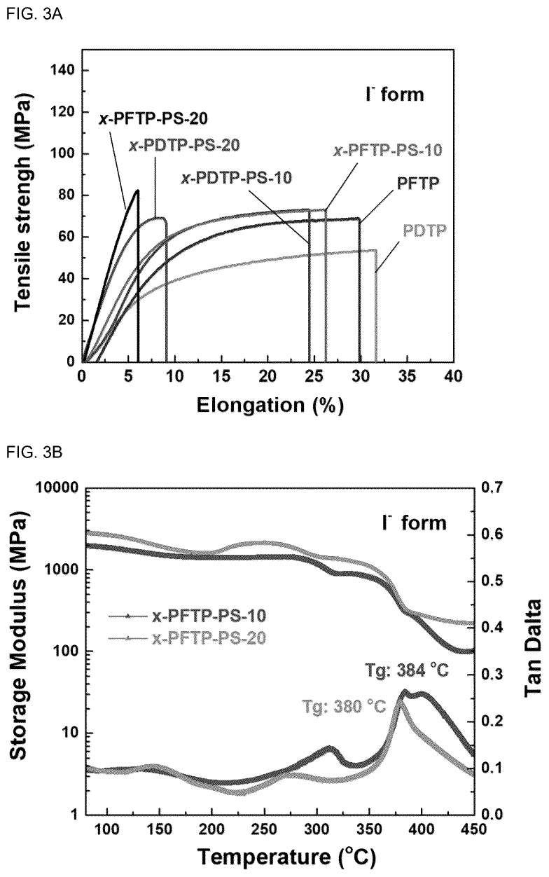

FIG. 3 shows the mechanical properties at room temperature (a) and dynamic mechanothermal properties (b) of some of the anion-exchange membranes (I-form) prepared in Example 7 of the present disclosure (prepared from the copolymer ionomers obtained in Examples 1 to 6) and the anion-exchange membranes prepared in Comparative Examples 1 and 2.

All the anion-exchange membranes displayed superior mechanical properties as compared to the previously known anion-exchange membranes, and the anion-exchange membranes with a cross-linked structure exhibited a high tensile strength of 80 MPa or higher compared to the anion-exchange membranes with no cross-linked structure. In particular, the x-PDTP-PS-10 and x-PFTP-PS-10 anion-exchange membranes with 10% degree of crosslinking showed a high tensile strength of 70 MPa or higher along with an appropriate elongation (25%).

Furthermore, the anion-exchange membranes with a cross-linked structure showed a high storage modulus (PFTP series: >2000 MPa) and showed a high glass transition temperature (Tg) of 380° C. or higher.

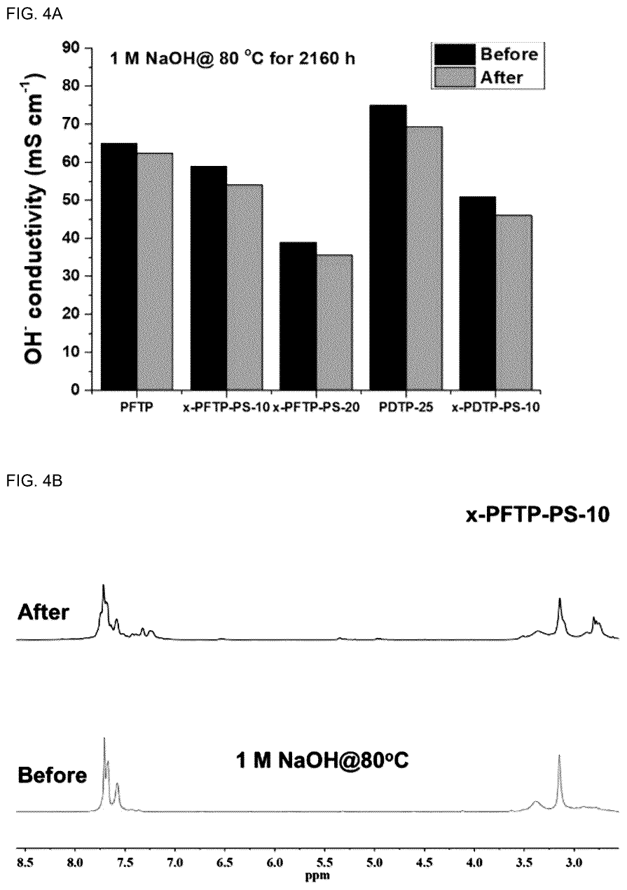

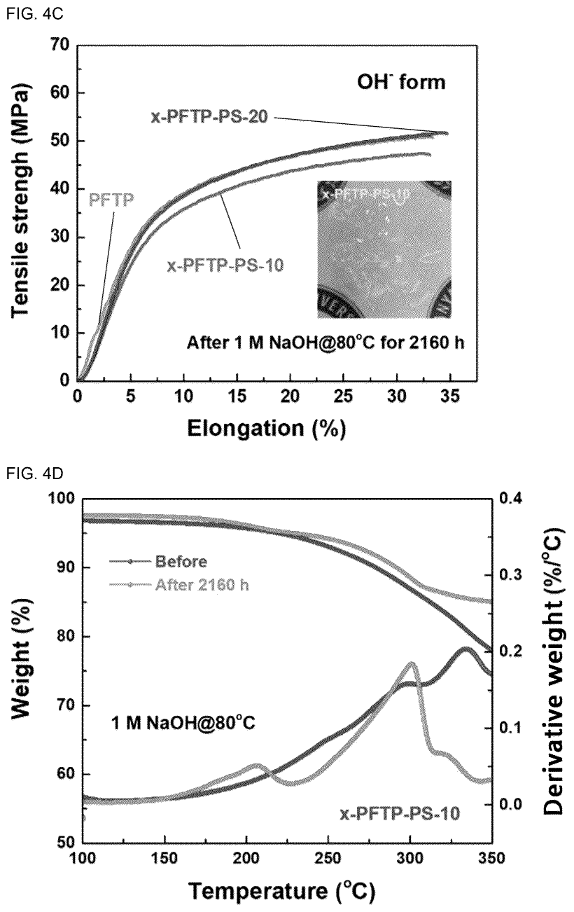

FIG. 4 shows a result of the ex-situ durability tests of some of the anion-exchange membranes (OH-form) prepared in Example 7 of the present disclosure (prepared from the copolymer ionomers obtained in Examples 1 to 6) and the anion-exchange membranes prepared in Comparative Examples 1 and 2 before and after immersion in 1 M NaOH at 80° C. for 2,160 hours [(a) change in OH-conductivity at 30° C., (b) 1H NMR spectra of x-PFTP-PS-10, (c) mechanical properties of anion-exchange membranes in OH-form after durability test, (d) thermogravimetric analysis (TGA) characteristics of x-PFTP-PS-10].

The alkaline stability of the anion-exchange membranes with a cross-linked structure was similar to that of the anion-exchange membranes with no cross-linked structure. Only a slight ion conductivity loss (<10%) was found after alkaline treatment for 2, 160 hours.

The PFTP series maintained excellent mechanical properties (tensile strength >50 MPa, elongation >30%) after alkaline stability testing for 2,160 hours, meaning that they are sufficiently mechanically tough for fuel cell applications.

Meanwhile, through thermogravimetric analysis (TGA) of the anion-exchange membranes having a cross-linked structure before and after alkaline treatment, it was found that they still maintain the ammonium groups within the polymer backbone after being immersed in 1 M NaOH for 2,160 hours.

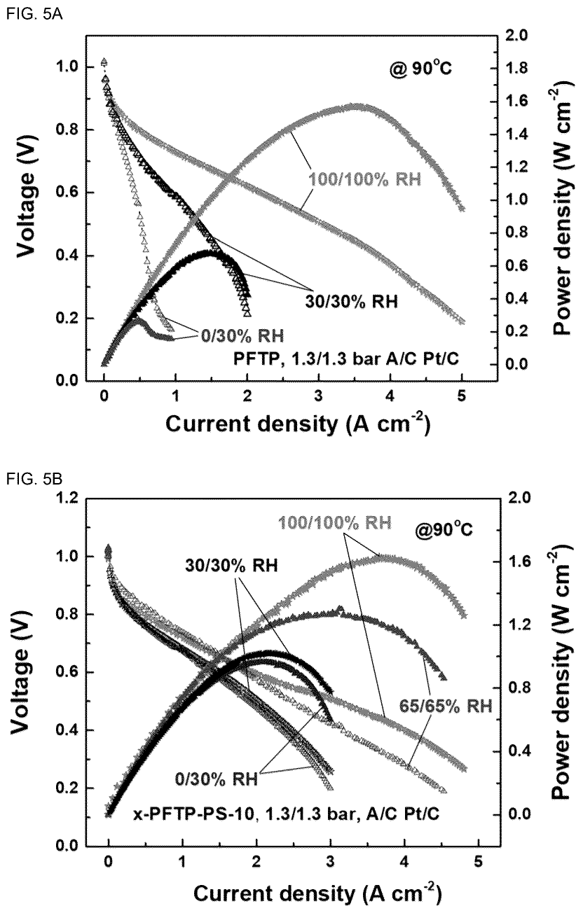

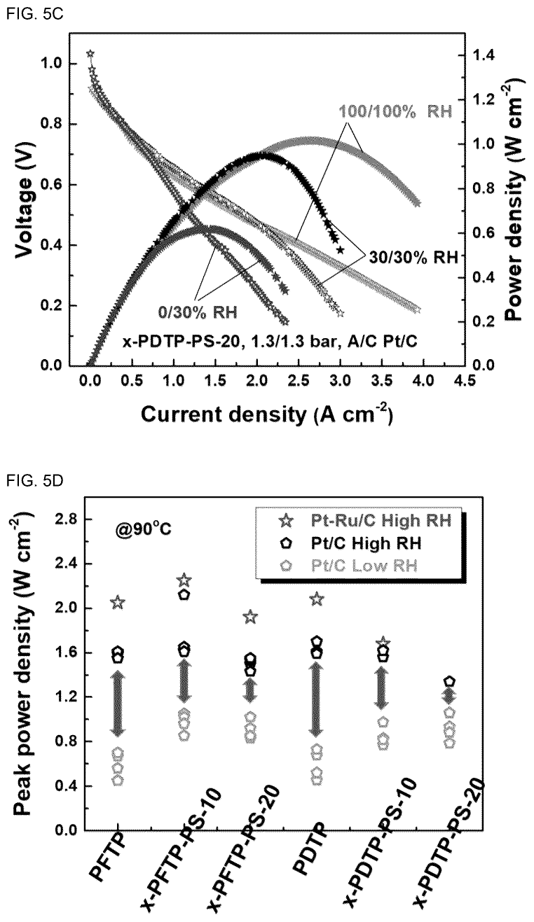

FIG. 5 shows the result of testing the fuel cell performance of some of the anion-exchange membranes (OH-form) prepared in Example 7 of the present disclosure (prepared from the copolymer ionomers obtained in Examples 1 to 6) and the anion-exchange membranes prepared in Comparative Examples 1 and 2 at low relative humidity and high temperature [test condition: A/C PFTP ionomer, 1,000/1,000 mL min⁻¹ H₂—O₂ flow rate, 0.33 mg cm⁻² A/C Pt/C, 90° C., 1.3/1.3 bar A/C pressure, (a) PFTP, (b) x-PFTP-PS-10, (c) x-PDTP-PS-20, (d) peak power density (PPD) of fuel cells at different relative humidity].

As shown in FIG. 5, the anion-exchange membrane fuel cells with a cross-linked structure showed stable PPDs at extremely low relative humidity. In particular, the fuel cell cells based on the x-PDTP-PS-10 and x-PFTP-PS-10 anion-exchange membranes were able to obtain PPDs of ˜1 Wcm-2 and ˜0.85 Wcm-2 at 30/30% and 0/30% relative humidity, respectively.

Furthermore, since the fuel cells based on the anion-exchange membranes with a cross-linked structure exhibit a low PPD gap between high relative humidity and low relative humidity, the anion-exchange membranes having a cross-linked structure possess higher water retention capacity than the conventional anion-exchange membranes with no cross-linked structure due to a network structure.

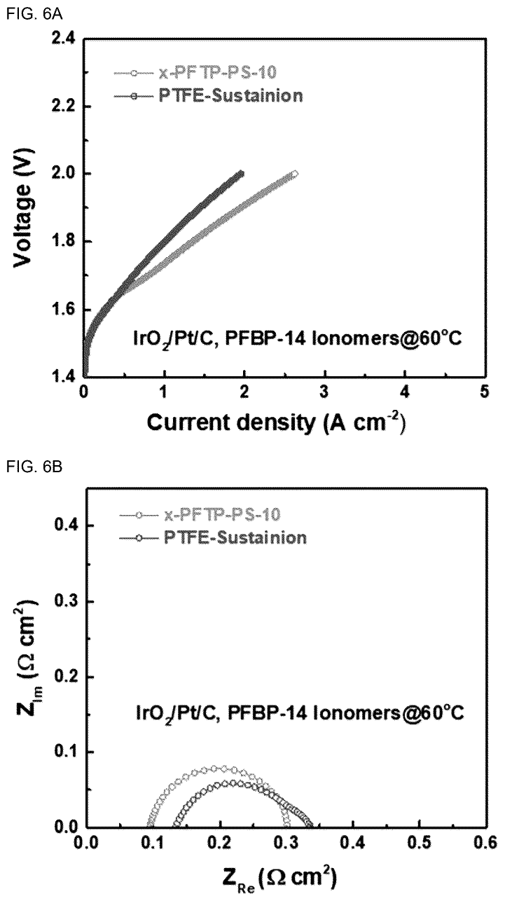

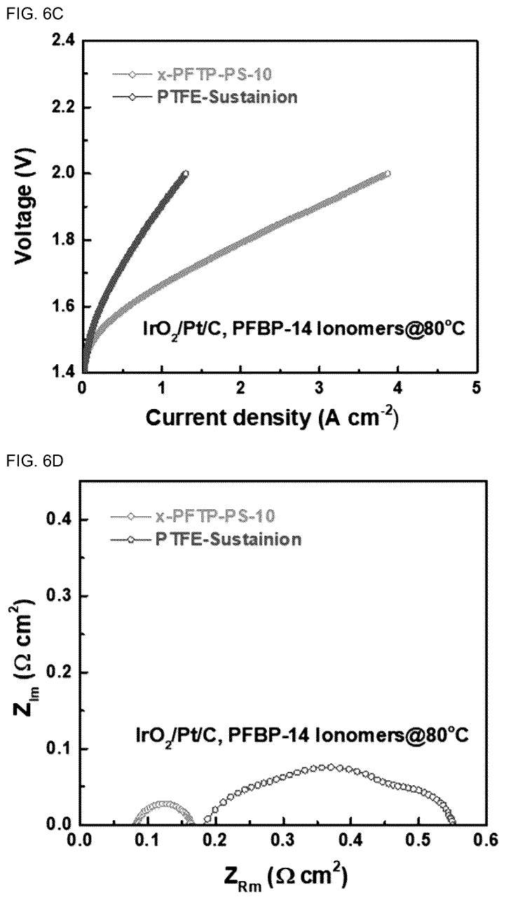

FIG. 6 shows the water electrolysis performance of different anion-exchange membranes at 2.0 V [test condition: A/C PFBP-14 ionomer, 1 M KOH feed, A/C IrO₂/Pt/C, (a) I-V curve measured at 60° C., (b) electrochemical impedance spectroscopy (EIS) spectrum, (c) I-V curve measured at 80° C., (d) electrochemical impedance spectroscopy (EIS) spectrum].

From the data shown in FIG. 6, it is expected that the x-PFTP-PS-10 anion-exchange membrane can also be applied to a water electrolysis device.

The water electrolysis device using the X-PFTP-PS-10 anion-exchange membrane exhibits a much higher current density at the same voltage as compared to the commercially available PTFE-Sustainion. Specifically, the water electrolysis device using the X-PFTP-PS-10 anion-exchange membrane exhibits a current density of 4 Acm-2 which is approximately 4 times higher than that of the water electrolysis device using the commercially available PTFE-Sustainion, which is probably due to the low ohmic resistance and charge transfer resistance.

1. A cross-linked poly(aryl piperidinium) copolymer ionomer having a repeating unit represented by <Chemical Formula 1>: 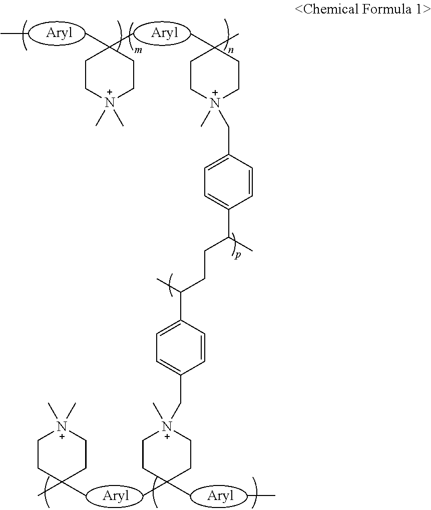
wherein Aryl represents two different types of compounds selected from the compounds represented by the following structural formulas: 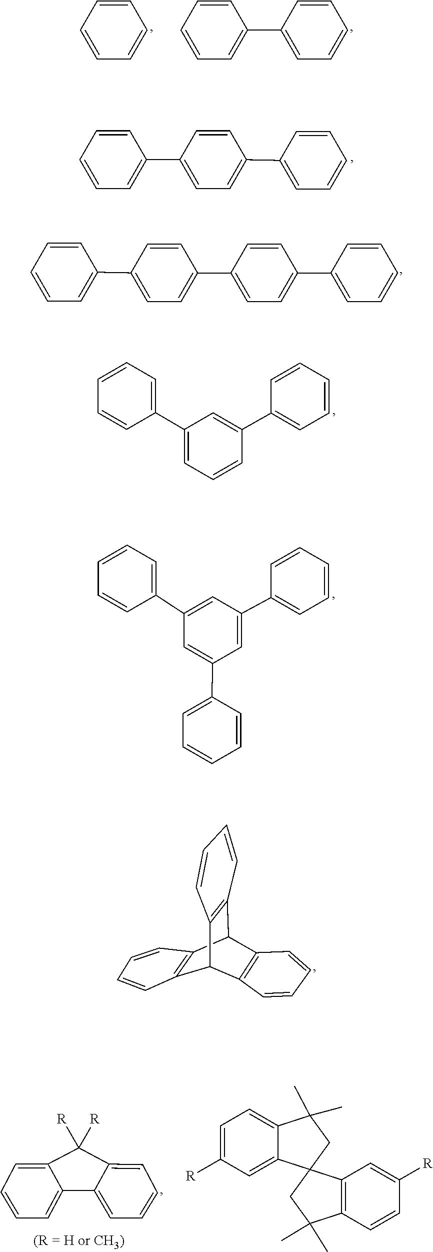
or C₁₋₅ alkoxy), 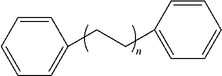
(n is an integer from 1 to 10); and
m, n are mole fractions (%) of in the repeating unit of the copolymer ionomer, wherein m>0, n>0, m+n=100, and p indicates degree of crosslinking adjusted to 20% or lower.

2. A method for preparing a cross-linked poly(aryl piperidinium) copolymer ionomer, comprising:
(I) a step of forming a solution by dissolving (a) two different types of compounds selected from compounds represented by the following structural formulas as monomers, and (b) 1-methyl-4-piperidone in an organic solvent; 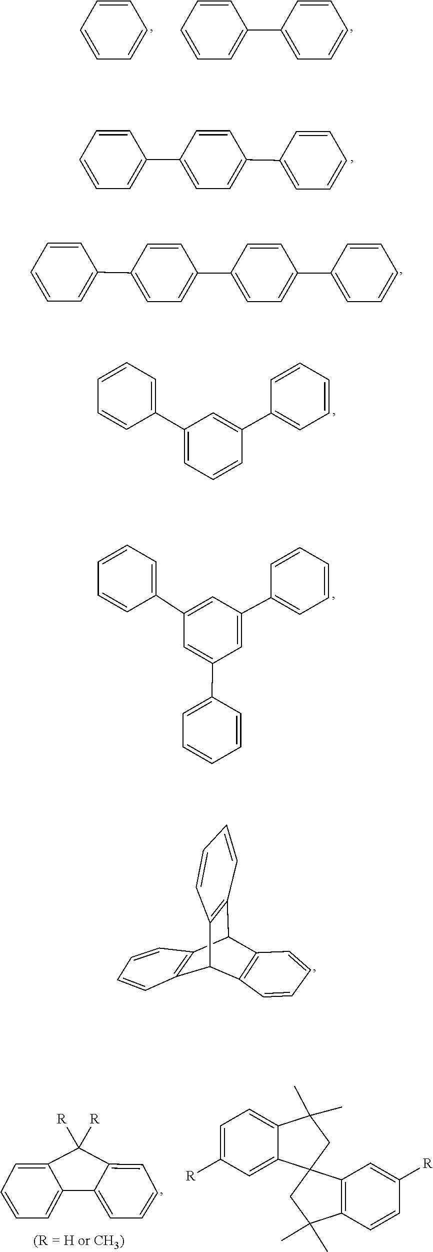
or C₁₋₅ alkoxy), 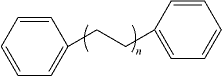
(n is an integer from 1 to 10)
(II) a step of obtaining a viscous solution by gradually adding a strong acid catalyst to the solution and stirring and reacting the same;
(III) a step of obtaining a solid polymer by precipitating, washing and drying the viscous solution;
(IV) a step of forming a quintenary piperidinium salt containing a styrene group by adding K₂CO₃, 4-vinylbenzyl chloride and an excessive amount of halomethane to a polymer solution in which the solid polymer and the strong acid catalyst are dissolved in an organic solvent and reacting the same; and
(V) a step of precipitating, washing, drying and then heat-treating the polymer solution.

3. The method for preparing a cross-linked poly(aryl piperidinium) copolymer ionomer according to claim 2, wherein the organic solvent in the step (I) is one or more halogen-based solvent selected from a group consisting of dichloromethane, chloroform, dichloroethane, dibromomethane, and tetrachloroethane.

4. The method for preparing a cross-linked poly(aryl piperidinium) copolymer ionomer according to claim 2, wherein the strong acid catalyst in the step (II) is trifluoroacetic acid, trifluoromethanesulfonic acid, pentafluoroethanesulfonic acid, heptafluoro-1-propanesulfonic acid, perfluoropropionic acid, heptafluorobutyric acid, or a mixture thereof.

5. The method for preparing a cross-linked poly(aryl piperidinium) copolymer ionomer according to claim 2, wherein the organic solvent in the step (IV) is N-methylpyrrolidone, dimethylacetamide, dimethyl sulfoxide, or dimethylformamide.

6. The method for preparing a cross-linked poly(aryl piperidinium) copolymer ionomer according to claim 2, wherein the halomethane in the step (IV) is fluoromethane, chloromethane, bromomethane, or iodometane.

7. An anion-exchange membrane comprising the cross-linked poly(aryl piperidinium) copolymer ionomer according to claim 1.

8. A method for preparing an anion-exchange membrane, comprising:
(i) a step of forming a polymer solution by dissolving the cross-linked poly(aryl piperidinium) copolymer ionomer according to claim 1 in an organic solvent;
(ii) a step of removing the organic solvent and obtaining a membrane in which crosslinking between styrene groups has been induced simultaneously by casting the polymer solution onto a glass plate and heating the same; and
(iii) a step of treating the obtained membrane with 1 M NaHCO₃ or 1 M NaOH and then washing several times with ultrapure water and drying the same.

9. The method for preparing an anion-exchange membrane according to claim 8, wherein the concentration of the polymer solution is 2 to 30 wt %.

10. The method for preparing an anion-exchange membrane according to claim 8, wherein, in the step (ii), the organic solvent is slowly removed in an oven at 80 to 90° C. for 24 hours and then the organic solvent is removed completely and, at the same time, crosslinking between styrene groups is induced by heating in a vacuum oven at 120 to 150° C. for 12 hours.

11. A binder for an alkaline fuel cell comprising the cross-linked poly(aryl piperidinium) copolymer ionomer according to claim 1.

12. An alkaline fuel cell comprising the anion-exchange membrane according to claim 7.

13. A water electrolysis device comprising the anion-exchange membrane according to claim 7.

14. A carbon dioxide reduction device comprising the anion-exchange membrane according to claim 7.

15. An oxidation-reduction flow battery comprising the anion-exchange membrane according to claim 7.
